(19) United States
(12) Patent Application Publication
(10) Pub. No.: US 2008/0307083 A1
(43) Pub. Date: Dec. 11, 2008

(54) GATEWAY MANAGED BY SPECIFIC DOMAIN NAME AND METHOD THEREOF

(75) Inventors: Wei-Chin Tsai, Hsinchu (TW); Yun-Fuh Yeh, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ARCADYAN TECHNOLOGY CORPORATION, Hsinchu (TW)

(21) Appl. No.: 11/937,503

(22) Filed: Nov. 9, 2007

(30) Foreign Application Priority Data
Jun. 6, 2007 (TW) 96120313

(51) Int. Cl. G06F 15/173

(52) U.S. Cl. 709/223

(57) ABSTRACT

A method of managing a gateway by a specific domain name is provided. The method includes firstly setting a DNS to connect to the internet. Next, a specific domain name for the gateway is defined. Then, the specific domain name is stored in the DNS for connecting the gateway according to the specific domain name. The present method maps the specific domain name to an IP address of the gateway, such that a user can manage the gateway by using the specific domain name instead of memorizing the IP address of the gateway, which is more convenient.

### CROSS-REFERENCE TO RELATED APPLICATION

This application claims the priority benefit of Taiwan application serial no. 96120313, filed Jun. 6, 2007. All disclosure of the Taiwan application is incorporated herein by reference.

### BACKGROUND OF THE INVENTION

1. Field of the Invention

The present invention relates to a method of managing a gateway, and more particularly to a method of managing a gateway by a specific domain name.

2. Description of Related Art

With an advancement of the internet, network communication services have been significantly improved. Data transmission among computers is no longer restricted by distance, and human beings tend to rely on network equipment to a greater degree. In the internet, an IP address of each host is unique, so as to ensure data can be transmitted to the only destination. As such, a source IP address and a destination IP address are defined in a header of a packet, so as to determine the destination to which the packet is delivered. As the packet is dispatched from the host of the source IP address, the packet is transmitted to a predetermined gateway of the host, and a next correspondence node to which the packet is going to be transmitted is determined by the header of the packet with use of the predetermined gateway. After the packet is routed through a plurality of the nodes, it can then be transmitted to the host of the destination IP address.

Generally, the gateway can function as a hub. Namely, a plurality of the hosts is connected through networking, and the hosts are then connected to the internet by the gateway. The gateway is not only able to connect different networks and forward the packets, but also capable of performing other functions, such as assigning the IP address to the host within a local area network (LAN), serving as a wireless access point, a modem, a web server, a file server, a firewall, and so on. Since the gateway plays diverse roles in coping with various demands, manufacturers aim at providing a management interface in the light of said demands, such that a user may configure the gateway based on the function it provides. The gateway and the user's host are connected to the same domain, and thus it is rather convenient and instinctive for the user to employ a web-based management interface for managing the gateway without connecting the gateway through other cables or interfaces.

Conventionally, before the gateway management interface is accessed for configuration, it is necessary to be aware of the IP address of the gateway at first, so as to connect to the gateway. In most cases, the IP address of the gateway is a private IP address by which the hosts within the LAN can access the gateway. The private IP address varies upon different manufacturers. After the IP address is input through a web browser or a terminal program, a screen for managing or logging in is then accessed.

However, the user has to memorize the IP address of the gateway for accessing the gateway management interface. Once the configured or revised IP address is forgotten, the gateway cannot be managed and configured anymore. Further, an IPv4 address is constituted by four groups of decimal digits ranging from 0 to 255, whereas an IPv6 address is written as eight groups of four hexadecimal digits. That is to say, it is required for the user to either memorize the IP address containing a great number of digits or refer to a cumbersome user manual, which is time-consuming and inconvenient.

### SUMMARY OF THE INVENTION

The present invention is directed to a method of managing a gateway by a specific domain name, such that a user is able to manage the gateway through the specific domain name instead of memorizing an IP address containing a great number of digits.

The present invention is directed to a gateway managed through a specific domain name by which a user is able to perform a management function provided by the gateway.

The present invention provides a method of managing a gateway by a specific domain name. The method includes firstly setting a domain name server (DNS) to connect to the internet. Next, a specific domain name for the gateway is defined. Then, the specific domain name is stored in the DNS for connecting to the gateway according to the specific domain name.

According to an embodiment of the present invention, the step of setting the DNS includes setting a dynamic host configuration protocol (DHCP) client and obtaining the IP address of the DNS by the DHCP.

According to an embodiment of the present invention, the step of storing the specific domain name in the DNS includes writing the specific domain name into a domain name record of the DNS, so as to map the specific domain name to the IP address of the gateway.

From another perspective, the present invention provides a gateway managed by a specific domain name. The gateway includes at least a wide area network (WAN) connecting unit, at least a LAN connecting unit, a DNS and a gateway management module. The gateway connects to the internet by the WAN connecting unit. The LAN connecting unit is coupled to the WAN connecting unit and at least a host. Besides, the DNS is coupled to the LAN connecting unit for providing a service of resolving a domain name. A domain name record is built in the DNS. It should be noted that the domain name record includes a specific domain name of the gateway, so as to map the specific domain name to an IP address of the gateway. The gateway management module is coupled to the LAN connecting unit for logging in, querying and setting the gateway.

Through a domain name resolution, the specific domain name is mapped to the IP address of the gateway in the present invention. Thereby, the user is capable of instinctively managing the gateway with use of the specific domain name, leading to convenience and time-efficiency due to unnecessity of referring to the user manual. Moreover, it is not obligatory to register the specific domain name on other DNSs, resulting in a liberty to name the specific domain.

In order to make the aforementioned and other objects, features and advantages of the present invention more comprehensible, several embodiments accompanied with figures are described in detail below.

### BRIEF DESCRIPTION OF THE DRAWINGS

FIG. 1A is a flowchart illustrating steps in a method of managing a gateway by a specific domain name according to an embodiment of the present invention.

FIG. 1B is a flowchart illustrating steps of connecting a gateway management tool through a web-based user interface.

FIG. 2 is an internal block diagram of a gateway managed by a specific domain name according to an embodiment of the present invention.

### DESCRIPTION OF EMBODIMENTS

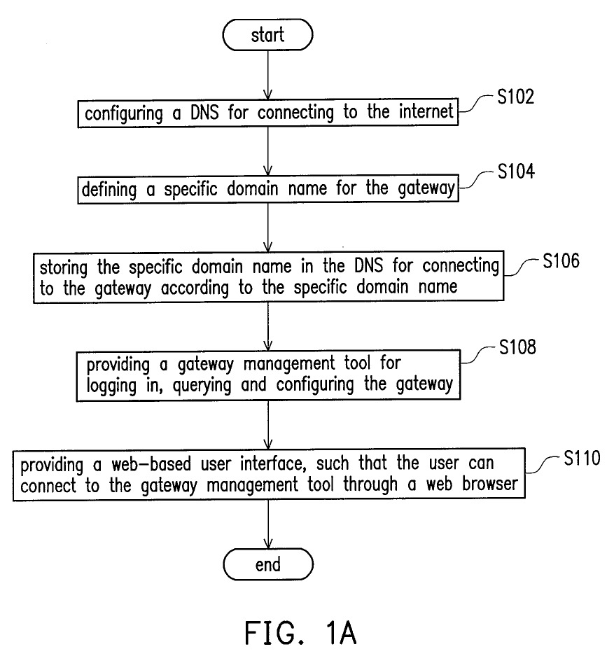

FIG. 1A is a flowchart illustrating steps in a method of managing a gateway by a specific domain name according to an embodiment of the present invention. Referring to FIG. 1, in step S102, a DNS is configured at first for connecting to the internet. In general, the DNS may be configured by directly writing an IP address of the DNS into a network configuration of a host. In the alternative, the host may be set as a DHCP client. After rebooting the host or restarting the network, the host can automatically obtain the IP address, a subnet mask, a default gateway, the IP address of the DNS, and so on through the DHCP.

In the present embodiment, the gateway is, for example, a digital subscriber line (xDSL) modem, a cable modem, an IP sharing device, a router or a wireless access point. Given that a plurality of the hosts is to be connected to the internet simultaneously, for example, the hosts may be connected to the IP sharing device by which the hosts can connect to the internet. The IP sharing device is able to assign the IP addresses of the DNSs to the hosts through the DHCP.

Next, in step S104, a specific domain name for the gateway is defined. The specific domain name may be given according to a brand name of the gateway, a product model thereof, or any other name that the user can instinctively memorize. The user can also define the specific domain name after accessing a configuration tool of the gateway. For example, the specific domain name can be set as “DeviceA.com” for the sake of memorization. Additionally, it is not necessary to draw the user's attention to legitimacy of the specific domain name on the internet.

Thereafter, in step S106, the specific domain name is stored in the DNS for connecting to the gateway according to the specific domain name. In detail, the specific domain name can be written into a domain name record of the DNS, so as to map the specific domain name to the IP address of the gateway. As the host is connected to the gateway based on the specific domain name, the host firstly issues a request for resolving the domain name to the DNS. After that, said request issued by the host is received by the DNS. The IP address of the gateway may then be obtained by issuing the request for querying the domain name record to resolve the specific domain name, for example. As such, the host is able to write the IP address of the gateway into a destination IP address field in a header of a data packet, and thus the data packet can be transmitted to the gateway for performing the management function.

In addition, after the specific domain name is stored in the DNS (step S106) according to the present embodiment, a gateway management tool may be provided in step S108 for logging in, querying and configuring the gateway. To be more specific, the gateway may be equipped with different functions based on different applications. Hence, in the present embodiment, the gateway management tool is provided for the user to manage the gateway in a more convenient manner, and the different functions may be integrated. With use of the gateway management tool, the user is able to manage the gateway by the specific domain name and by remote connection.

In step S110, a web-based user interface is provided, such that the user can connect to the gateway management tool through a web browser. FIG. 1B is a flowchart illustrating steps of connecting to the gateway management tool through the web-based user interface. With reference to FIG. 1B, in step S202, the web browser is firstly initiated. After that, in step S204, the specific domain name is input in a URL bar of the web browser, so as to access the web-based user interface. Afterwards, in step S206, the DNS is adopted to resolve the specific domain name, so as to obtain the IP address. Finally, in step S208, the gateway is connected to through a hypertext transfer protocol (HTTP) by using the IP address. Thereby, the user is able to manage the gateway by using the web-based user interface.

The specific domain name configured as “DeviceA.com” is taken for an example. The specific domain name “DeviceA.com” is stored in the domain name record of the DNS. After the user inputs a URL “http://DeviceA.com” to the URL bar of the web browser, the DNS starts resolving the specific domain name “DeviceA.com”. After the DNS searches the domain name record, the IP address of the gateway can be obtained, and the user's host can then be informed. Thereafter, the user's host can connect to the gateway through the HTTP for managing the gateway through the web-based user interface.

Based on the above, the method of managing the gateway by the specific domain name according to the present embodiment allows the user to access the gateway through the specific domain name in a convenient and instinctive manner without memorizing the IP address containing a greater number of digits, and thereby the gateway can be managed.

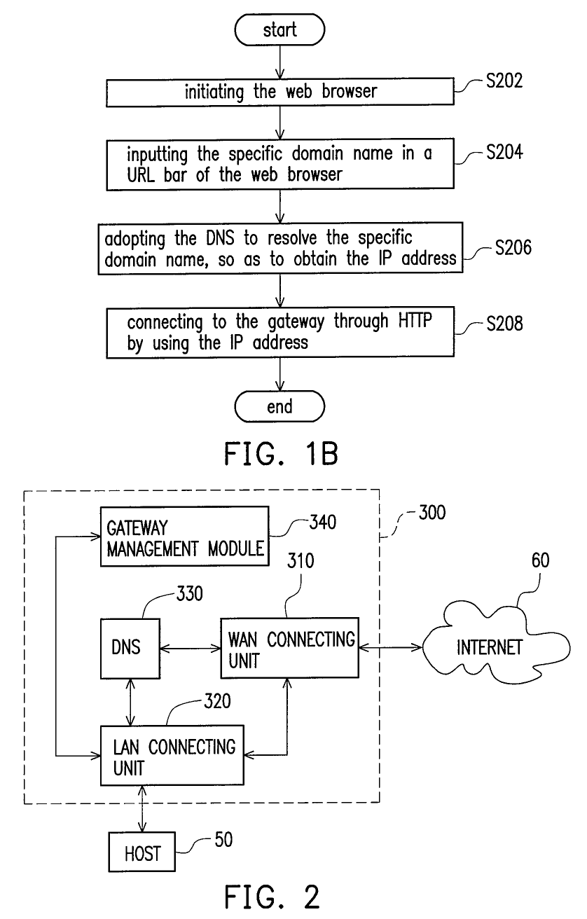

FIG. 2 is an internal block diagram of a gateway managed by a specific domain name according to an embodiment of the present invention. Referring to FIG. 2, a gateway 300 provided by the present invention is capable of connecting a host 50 to an internet 60. In the present embodiment, the gateway 300 is, for example, an xDSL modem, a cable modem, an IP sharing device, a router or a wireless access point.

Here, the gateway 300 of the present invention includes at least a WAN connecting unit 310, at least a LAN connecting unit 320, a DNS 330 and a gateway management module 340. The LAN connecting unit 320 may be coupled to the host 50, the DNS 330 and the gateway management module 340. Besides, the DNS 330 is coupled to the WAN connecting unit 310. In the present embodiment, the user may configure a specific domain name (e.g. “DeviceA.com” indicated hereinbefore) for the gateway 300, and the specific domain name is stored in the DNS 330.

As the user connects to the internet 60 through the host 50, a web browser in the host 50 should be activated first, and a name of a website to be accessed is input to the web browser. On the other hand, a resolving request can be issued by the host 50 to the DNS 330 through the LAN connecting unit 320. Here, the DNS 330 firstly searches a domain name record to determine if an IP address corresponding to the domain name in the web browser is found. When no relevant IP address is observed by the DNS 330, the IP address corresponding to the domain name may be acquired by inquiring the DNS in an upper level with use of the WAN connecting unit 310.

Relatively, when the IP address associated with the domain name input by the user is found by the DNS 330, the DNS 330 may connect the host 50 to the internet 60 through the WAN connecting unit 310. Besides, the corresponding web pages are transmitted to the host 50 via the internet 60, the WAN connecting unit 310 and the LAN connecting unit 320.

Aside from the foregoing, as the user configures the gateway 300, the web browser in the host 50 can be firstly invoked, and the specific domain name corresponding to the gateway 300 can then be input to the web browser. Here, the DNS 330 receives the specific domain name from the host 50 via the LAN connecting unit 320, and the IP address mapped thereby is transmitted to the host 50. Thereafter, the host 50 transmits the packet to the IP address and connects to the gateway management module 340 through the LAN connecting unit 320. In other words, after the user inputs the specific domain name to the web browser, the web page of the gateway 300 for managing or logging in is then accessed to advance the configuration and to retrieve information as to network connections. Thereby, the user need not bother to memorize the IP address of the gateway 300.

In summary, the present invention has at least the following advantages:

In the present invention, the domain name resolution is utilized to map the specific domain name to the IP address of the gateway. Thereby, the user is capable of instinctively managing the gateway with use of the specific domain name rather than memorizing the IP address containing a great number of digits, leading to convenience and time-efficiency due to unnecessity of referring to the user manual.

In the present invention, the specific domain name mapped to the IP address of the gateway is stored in the domain name record. As such, it is not necessary to inquire the DNS in an upper level during the resolution of the domain name. That is to say, the specific domain name requires no register on other DNSs on the internet. Moreover, the user's attention does not need to be drawn to legitimacy of the specific domain name on the internet, resulting in the liberty to name the specific domain upon the user's expectation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of managing a gateway by a specific domain name, comprising:
setting a domain name server (DNS) for connecting to an internet;
defining a specific domain name for the gateway; and
storing the specific domain name in the DNS, so as to connect to the gateway according to the specific domain name.

2. The method of claim 1, wherein the step of setting the DNS comprises:
obtaining an IP address of the DNS; and
setting the IP address of a DNS in a network configuration.

3. The method of claim 2, wherein the step of obtaining the IP address of the DNS comprises:
setting a dynamic host configuration protocol (DHCP) client, wherein the client is connected to the internet through the gateway; and
obtaining the IP address of the DNS by the DHCP.

4. The method of claim 1, wherein the step of storing the specific domain name in the DNS comprises:
writing the specific domain name into a domain name record of the DNS, so as to map the specific domain name to an IP address of the gateway.

5. The method of claim 1, wherein the step of connecting the gateway according to the specific domain name comprises:
issuing a request for resolving the domain name to the DNS;
obtaining an IP address by resolving the specific domain name with use of the DNS; and
connecting to the gateway through the IP address.

6. The method of claim 1, further comprising:
providing a gateway management tool for logging in, querying and configuring the gateway; and
providing a web-based user interface, such that a user connects to the gateway management tool through a web browser.

7. The method of claim 6, further comprising:
inputting the specific domain name to a URL bar of the web browser, so as to connect to a web-based user interface;
obtaining an IP address by resolving the specific domain name with use of the DNS; and
connecting the gateway through a hypertext transfer protocol (HTTP) with use of the IP address.

8. The method of claim 1, wherein the gateway is a digital subscriber line (xDSL) modem, a cable modem, an IP sharing device, a router or a wireless access point.

9. A method of managing a gateway by a specific domain name, comprising:
setting a domain name server (DNS) for connecting to an internet;
defining a specific domain name for the gateway;
storing the specific domain name in the DNS and mapping the specific domain name to an IP address of the gateway;
issuing a request for resolving the domain name to the DNS and obtaining an IP address by resolving the specific domain name with use of the DNS; and
connecting to the gateway through the IP address.

10. The method of claim 9, wherein the step of setting the DNS comprises:
obtaining an IP address of the DNS; and
setting the IP address of a DNS in a network configuration.

11. The method of claim 10, wherein the step of obtaining the IP address of the DNS comprises:
setting a dynamic host configuration protocol (DHCP) client, wherein the client is connected to the internet through the gateway; and
obtaining the IP address of the DNS by the DHCP.

12. The method of claim 9, further comprising:
providing a gateway management tool for logging in, querying and configuring the gateway; and
providing a web-based user interface, such that a user connects to the gateway management tool through a web browser.

13. The method of claim 12, further comprising:
inputting the specific domain name to a URL bar of the web browser, so as to connect to a web-based user interface;
obtaining an IP address by resolving the specific domain name with use of the DNS; and
connecting the gateway through a hypertext transfer protocol (HTTP) with use of the IP address.

14. The method of claim 9, wherein the gateway is a digital subscriber line (xDSL) modem, a cable modem, an IP sharing device, a router or a wireless access point.

15. A gateway managed by a specific domain name, comprising:
at least a wide area network (WAN) connecting unit for connecting an internet;
at least a local area network (LAN) connecting unit coupled to the WAN connecting unit and to at least a host;
a DNS coupled to the LAN connecting unit and the WAN connecting unit for providing a service of resolving a domain name, wherein a domain name record is built in the DNS, and the domain name record comprises a specific domain name of the gateway for mapping the specific domain name to an IP address of the gateway; and
a gateway management module coupled to the LAN connecting unit for logging in, querying and configuring the gateway.

16. The gateway managed by the specific domain name of claim 15, wherein the gateway management module has a web-based user interface, such that a user connects to the gateway management module through web pages.

17. The gateway managed by the specific domain name of claim 15, wherein the gateway is an xDSL modem, a cable modem, an IP sharing device, a router or a wireless access point.
